(19) United States
(12) Patent Application Publication
(10) Pub. No.: US 2023/0252201 A1
(43) Pub. Date: Aug. 10, 2023

(54) USING A FABRICATION MODEL ESTIMATOR FOR INVERSE DESIGN OF PHYSICAL DEVICES

(71) Applicant: X Development LLC, Mountain View, CA (US)

(72) Inventors: Ian Alexander Durant Williamson, Palo Alto, CA (US); Martin Schubert, Mountain View, CA (US); Alfred Ka Chun Cheung, Belmont, CA (US)

(21) Appl. No.: 17/667,307

(22) Filed: Feb. 8, 2022

(51) Int. Cl. G06F 30/20

(52) U.S. Cl. CPC G06F 30/20; G06F 2113/10

(57) ABSTRACT

Techniques for optimizing a design for a physical device to be fabricated by a fabrication system are disclosed. A computing system receives an initial design of the physical device. The computing system simulates fabrication of the physical device using a fabrication model associated with the fabrication system to determine predicted structural parameters. The computing system determines a gradient of the fabrication model based on an estimator. The computing system backpropagates the gradient of the fabrication model to update the predicted structural parameters and thereby generate updated structural parameters. The computing system backpropagates a gradient associated with the updated structural parameters to update the initial design and thereby generate an updated initial design. In some embodiments, the updated initial design is transmitted to the fabrication system for fabrication of the physical device.

### TECHNICAL FIELD

This disclosure relates generally to the design of physical devices for fabrication, and in particular but not exclusively, relates to photonic devices including but not limited to optical multiplexers and demultiplexers.

### BACKGROUND

Fiber-optic communication is typically employed to transmit information from one place to another via light that has been modulated to carry the information. For example, many telecommunication companies use optical fiber to transmit telephone signals, internet communication, and cable television signals. But the cost of deploying optical fibers for fiber-optic communication may be prohibitive. As such, techniques have been developed to more efficiently use the bandwidth available within a single optical fiber. Wavelength-division multiplexing is one such technique that bundles multiple optical carrier signals onto a single optical fiber using different wavelengths. Fabrication techniques used to create physical devices such as photonic devices for use in these contexts can create complex physical structures, but a fabricated physical device may differ from the design of the physical device due to specifics of the fabrication process as implemented by a particular fabrication system.

### BRIEF SUMMARY

In some embodiments, a non-transitory computer-readable medium is provided. The computer-readable medium has logic stored thereon that, in response to execution by one or more processors of a computing system, causes the computing system to perform actions for optimizing a design for a physical device to be fabricated by a fabrication system. The actions comprise receiving, by the computing system, an initial design of the physical device; simulating, by the computing system, fabrication of the physical device using a fabrication model associated with the fabrication system to determine predicted structural parameters; determining, by the computing system, a gradient of the fabrication model based on an estimator; backpropagating, by the computing system, the gradient of the fabrication model to update the predicted structural parameters and thereby generate updated structural parameters; and backpropagating, by the computing system, a gradient associated with the updated structural parameters to update the initial design and thereby generate an updated initial design.

In some embodiments, a computer-implemented method of optimizing a design for a physical device to be fabricated by a fabrication system is provided. A computing system receives an initial design of the physical device. The computing system simulates fabrication of the physical device using a fabrication model associated with the fabrication system to determine predicted structural parameters. The computing system determines a gradient of the fabrication model based on an estimator. The computing system backpropagates the gradient of the fabrication model to update the predicted structural parameters and thereby generate updated structural parameters. The computing system backpropagates a gradient associated with the updated structural parameters to update the initial design and thereby generate an updated initial design.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a functional block diagram illustrating a non-limiting example embodiment of a system for optical communication between two optical communication devices via an optical signal, according to various aspects of the present disclosure.

FIG. 2A and FIG. 2B respectively illustrate a non-limiting example embodiment of a demultiplexer and multiplexer, according to various aspects of the present disclosure.

FIG. 2C illustrates a non-limiting example embodiment of a distinct wavelength channel of a multi-channel optical signal, according to various aspects of the present disclosure.

FIG. 3A-FIG. 3D illustrate different views of a non-limiting example embodiment of a photonic demultiplexer, according to various aspects of the present disclosure.

FIG. 4A and FIG. 4B illustrate a more detailed cross-sectional view of a dispersive region of a non-limiting example embodiment of a photonic demultiplexer, according to various aspects of the present disclosure.

FIG. 5 is a functional block diagram illustrating a non-limiting example embodiment of a system for generating a design of a photonic integrated circuit, according to various aspects of the present disclosure.

FIG. 6A illustrates a non-limiting example embodiment of a virtual prototype describing a photonic integrated circuit, according to various aspects of the present disclosure.

FIG. 6B illustrates a non-limiting example embodiment of an operational simulation of a photonic integrated circuit, according to various aspects of the present disclosure.

FIG. 6C illustrates a non-limiting example embodiment of an adjoint simulation within the virtual prototype by backpropagating a loss value, according to various aspects of the present disclosure.

FIG. 7A is a flow chart illustrating example time steps for an operational simulation and an adjoint simulation, in accordance with various aspects of the present disclosure.

FIG. 7B is a chart illustrating the relationship between the update operation for the operational simulation and the adjoint simulation (e.g., backpropagation), in accordance with an embodiment of the present disclosure.

FIG. 8A-FIG. 8C illustrate a non-limiting example embodiment of generating predicted structural parameters using a fabrication model according to various aspects of the present disclosure.

FIG. 9A is a chart that illustrates a non-limiting example of a fabrication model using a first value for a beta parameter, and FIG. 9B is a chart that illustrates a non-limiting example of the fabrication model using a second value for the beta parameter.

FIG. 10 is a flowchart that illustrates a non-limiting example embodiment of a method of optimizing a design of a physical device such as a photonic integrated circuit, in accordance with various aspects of the present disclosure.

### DETAILED DESCRIPTION

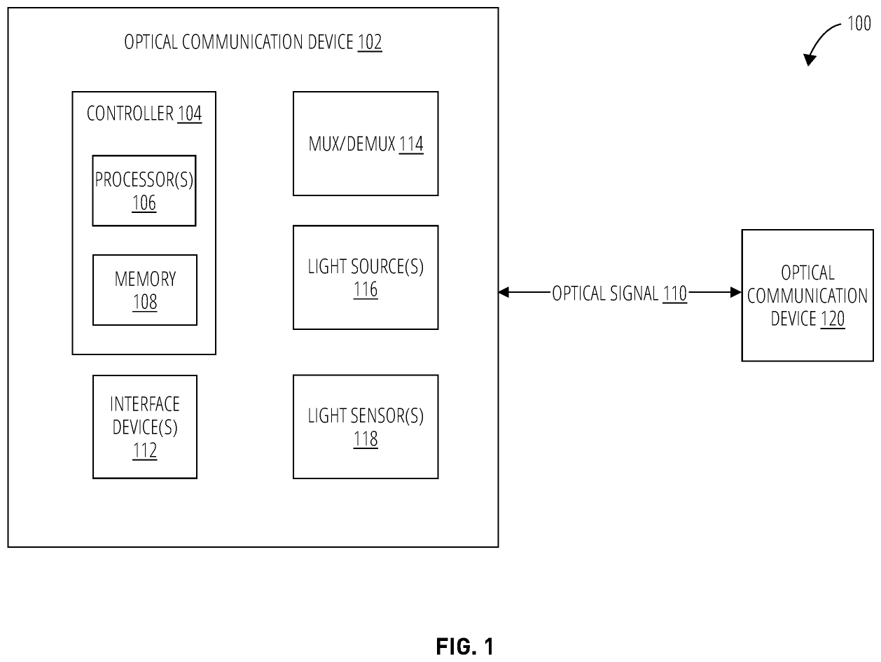

FIG. 1 is a functional block diagram illustrating a system 100 for optical communication (e.g., via wavelength division multiplexing or other techniques) between optical communication device 102 and optical communication device 120 via optical signal 110, in accordance with various aspects of the present disclosure. More generally, optical communication device 102 is configured to transmit information by modulating light from one or more light sources into a multi-channel optical signal 110 (e.g., a singular optical signal that includes a plurality of distinct wavelength channels) that is subsequently transmitted from optical communication device 102 to optical communication device 120 via an optical fiber, a light guide, a waveguide, or other photonic device. Optical communication device 120 receives the multi-channel optical signal 110 and demultiplexes each of the plurality of distinct wavelength channels from the multi-channel optical signal 110 to extract the transmitted information. It is appreciated that in some embodiments optical communication device 102 and optical communication device 120 may be distinct and separate devices (e.g., an optical transceiver or transmitter communicatively coupled via one or more optical fibers to a separate optical transceiver or receiver). However, in other embodiments, optical communication device 102 and optical communication device 120 may be part of a singular component or device (e.g., a smartphone, a tablet, a computer, optical device, or the like). For example, optical communication device 102 and optical communication device 120 may both be constituent components on a monolithic integrated circuit that are coupled to one another via a waveguide that is embedded within the monolithic integrated circuit and is adapted to carry optical signal 110 between optical communication device 102 and optical communication device 120 or otherwise transmit the optical signal between one place and another.

In the illustrated embodiment, optical communication device 102 includes a controller 104, one or more interface device(s) 112 (e.g., fiber optic couplers, light guides, waveguides, and the like), a multiplexer (mux), demultiplexer (demux), or combination thereof (MUX/DEMUX 114), one or more light source(s) 116 (e.g., light emitting diodes, lasers, and the like), and one or more light sensor(s) 118 (e.g., photodiodes, phototransistors, photoresistors, and the like) coupled to one another. The controller includes one or more processor(s) 106 (e.g., one or more central processing units, application specific circuits, field programmable gate arrays, or otherwise) and memory 108 (e.g., volatile memory such as DRAM and SAM, non-volatile memory such as ROM, flash memory, and the like). It is appreciated that optical communication device 120 may include the same or similar elements as optical communication device 102, which have been omitted for clarity.

Controller 104 orchestrates operation of optical communication device 102 for transmitting and/or receiving optical signal 110 (e.g., a multi-channel optical signal having a plurality of distinct wavelength channels or otherwise). Controller 104 includes software (e.g., instructions included in memory 108 coupled to processor 106) and/or hardware logic (e.g., application specific integrated circuits, field-programmable gate arrays, and the like) that when executed by controller 104 causes controller 104 and/or optical communication device 102 to perform operations.

In one embodiment, controller 104 may choreograph operations of optical communication device 102 to cause light source(s) 116 to generate a plurality of distinct wavelength channels that are multiplexed via MUX/DEMUX 114 into a multi-channel optical signal 110 that is subsequently transmitted to optical communication device 120 via interface device 112. In other words, light source(s) 116 may output light having different wavelengths (e.g., 1271 nm, 1291 nm, 1311 nm, 1331 nm, 1506 nm, 1514 nm, 1551 nm, 1571, or otherwise) that may be modulated or pulsed via controller 104 to generate a plurality of distinct wavelength channels representative of information. The plurality of distinct wavelength channels are subsequently combined or otherwise multiplexed via MUX/DEMUX 114 into a multi-channel optical signal 110 that is transmitted to optical communication device 120 via interface device 112. In the same or another embodiment, controller 104 may choreograph operations of optical communication device 102 to cause a plurality of distinct wavelength channels to be demultiplexed via MUX/DEMUX 114 from a multi-channel optical signal 110 that is received via interface device 112 from optical communication device 120.

It is appreciated that in some embodiments certain elements of optical communication device 102 and/or optical communication device 120 may have been omitted to avoid obscuring certain aspects of the disclosure. For example, optical communication device 102 and optical communication device 120 may include amplification circuitry, lenses, or components to facilitate transmitting and receiving optical signal 110. It is further appreciated that in some embodiments optical communication device 102 and/or optical communication device 120 may not necessarily include all elements illustrated in FIG. 1. For example, in one embodiment optical communication device 102 and/or optical communication device 120 are passive devices that operate as an intermediary device that may passively multiplex a plurality of distinct wavelength channels into a multi-channel optical signal 110 and/or demultiplex a plurality of distinct wavelength channels from a multi-channel optical signal 110.

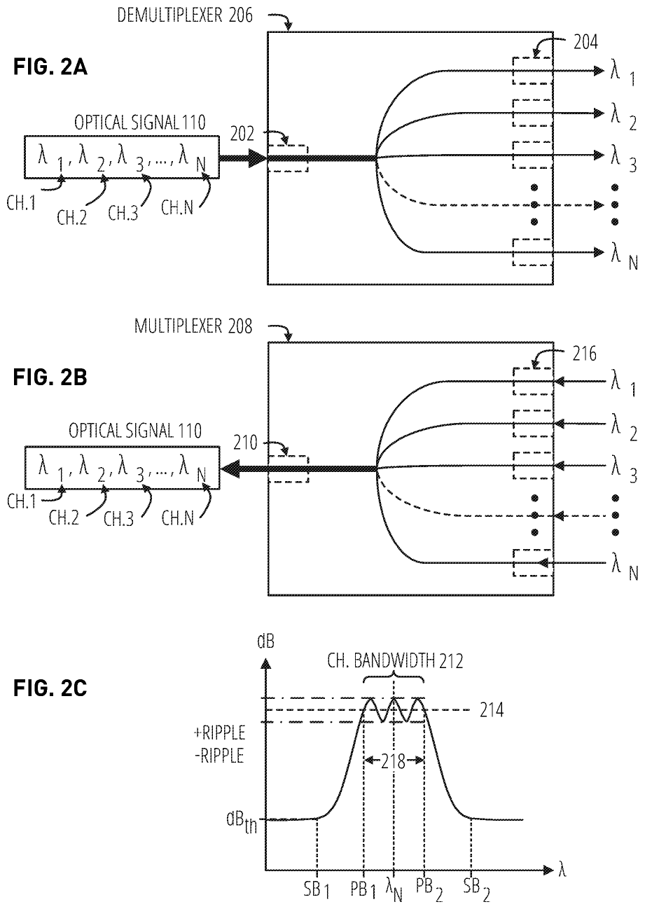

FIG. 2A and FIG. 2B respectively illustrate an example demultiplexer 206 and multiplexer 208, in accordance with various aspects of the present disclosure. Demultiplexer 206 and multiplexer 208 are possible embodiments of MUX/DEMUX 114 illustrated in FIG. 1, and which may be part of an integrated photonic circuit, silicon photonic device, or otherwise

As illustrated in FIG. 2A, demultiplexer 206 includes an input region 202 and a plurality of output regions 204. Demultiplexer 206 is configured to receive a multi-channel optical signal 110 that includes a plurality of distinct wavelength channels (e.g., Ch. 1, Ch. 2, Ch. 3, . . . Ch. N, each having a center wavelength respectively corresponding to λ₁, λ₂, λ₃, . . . λ_{N}) via input region 202 (e.g., a waveguide that may correspond to interface device 112 illustrated in FIG. 1) to optically separate each of the plurality of distinct wavelength channels from the multi-channel optical signal 110 and respectively guide each of the plurality of distinct wavelength channels to a corresponding one of a plurality of output regions 204 (e.g., a plurality of waveguides that may correspond to interface device(s) 112 illustrated in FIG. 1). More specifically, in the illustrated embodiment, each of the output regions 204 receives a portion of the multi-channel optical signal that corresponds to, or is otherwise representative of, one of the plurality of distinct wavelength channels that may be output as plurality of optical signals (e.g., λ₁, λ₂, λ₃, . . . λ_{N}). Each output region 204 may be coupled to a respective light sensor (e.g., corresponding to light sensor(s) 118 illustrated in FIG. 1), which may be utilized to convert the optical signals demultiplexed from the multi-channel optical signal 110 into electrical signals for further processing.

In the illustrated embodiment of FIG. 2B, multiplexer 208 includes a plurality of input regions 216 and an output region 210. Multiplexer 208 is configured to receive a plurality of distinct optical signals (e.g., λ₁, λ₂, λ₃, . . . λ_{N}), each at a respective one of the plurality of input regions 216 (e.g., a plurality of waveguides that may correspond to interface device(s) 112 illustrated in FIG. 1). Multiplexer 208 is structured or otherwise configured to optically combine (i.e., multiplex) each of the plurality of distinct wavelength channels into a multi-channel optical signal 110 that is guided to output region 210 (e.g., a waveguide that may correspond to interface device 112 illustrated in FIG. 1). It is appreciated that in some embodiments, demultiplexer 206 illustrated in FIG. 2A and multiplexer 208 illustrated in FIG. 2B may be bidirectional such that each device may function as both a demultiplexer and multiplexer.

FIG. 2C illustrates an example distinct wavelength channel of a multi-channel optical signal (e.g., Ch. N is multi-channel optical signal 110 illustrated in FIG. 1, FIG. 2A, and FIG. 2B), in accordance with various aspects of the present disclosure. The example channel may be representative of an individual channel included in a plurality of distinct wavelength channels of the multi-channel optical signal that may be demultiplexed and/or multiplexed by demultiplexer 206 of FIG. 2A and/or multiplexer 208 of FIG. 2B. Each of the distinct wavelength channels may have different center wavelengths (λ_{N}) including at least one of 1271 nm, 1291 nm, 1311 nm, 1331 nm, 1506 nm, 1514 nm, 1551 nm, or 1571 nm, or otherwise. In the illustrated embodiment of FIG. 2C, the distinct wavelength channel has a channel bandwidth 212 of approximately 13 nm wide. However, in other embodiments the channel bandwidth may be different than 13 nm wide. Rather, the channel bandwidth may be considered a configurable parameter that is dependent upon the structure of MUX/DEMUX 114 of FIG. 1, demultiplexer 206 of FIG. 2A, and/or multiplexer 208 of FIG. 2B. For example, in some embodiments each of the plurality of distinct wavelength channels may share a common bandwidth that may correspond to 13 nm or otherwise. Referring back to FIG. 2C, the channel bandwidth 212 may be defined as the width of a passband region 218 (i.e., the region defined as being between PB₁ and PB₂). The passband region 218 may represent an approximate power transmission of a demultiplexer or multiplexer. It is appreciated that in some embodiments the passband region 218 may include ripple as illustrated in FIG. 2C, which corresponds to fluctuations within the passband region 218. In one or more embodiments, the ripple within the passband region around a central value 214 may be +/−2 dB or less, +/−1 dB or less, +/−0.5 dB or less, or otherwise. In some embodiments, the channel bandwidth 212 may be defined by the passband region 218. In other embodiments, the channel bandwidth 212 may be defined as the measured power above a threshold (e.g., dBₜₕ). For example, demultiplexer 206 illustrated in FIG. 2A may optically separate channel N from multi-channel optical signal 110 and have a corresponding channel bandwidth for channel N equivalent to the range of wavelengths above a threshold value that are transmitted to the output region 204 mapped to channel N (i.e., λ_{N}). In the same or other embodiments, isolation of the channel (i.e., defined by channel bandwidth 212) may also be considered when optimizing the design. The isolation may be defined as a ratio between the power transmission in the passband region 218 and the power transmission in the stopband regions (e.g., regions less than SB₁ and greater than SB₂). It is further appreciated that transition band regions (e.g., a first transition region between SB₁ and PB₁ and a second transition region between PB₂ and SB₂) are exemplary and may be exaggerated for the purposes of illustration. In some embodiments, optimization of the design of the photonic demultiplexer may also include a target metric for a slope, width, or the like of the transition band regions.

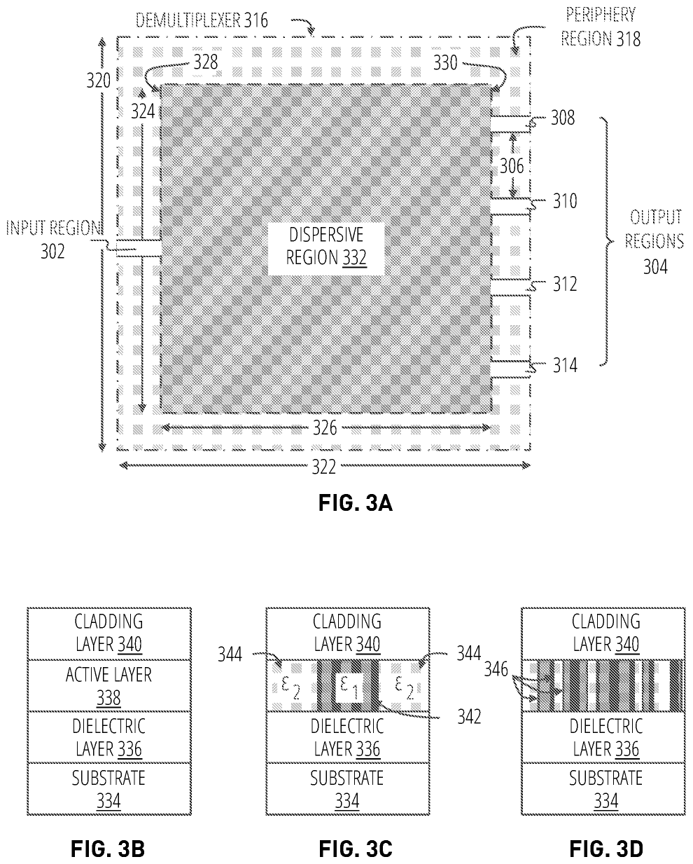

FIG. 3A-FIG. 3D illustrate different views of an example photonic demultiplexer, in accordance with an embodiment of the present disclosure. Photonic demultiplexer 316 is one possible implementation of MUX/DEMUX 114 illustrated in FIG. 1 and demultiplexer 206 illustrated in FIG. 2A. It is further appreciated that while discussion henceforth may be directed towards photonic integrated circuits capable of demultiplexing a plurality of distinct wavelength channels from a multi-channel optical signal, that in other embodiments, a demultiplexer (e.g., demultiplexer 316) may also or alternatively be capable of multiplexing a plurality of distinct wavelength channels into a multi-channel optical signal, in accordance with embodiments of the present disclosure.

FIG. 3A illustrates a cross-sectional view of demultiplexer 316 along a lateral plane within an active layer defined by a width 320 and a length 322 of the demultiplexer 316. As illustrated, demultiplexer 316 includes an input region 302 (e.g., comparable to input region 202 illustrated in FIG. 2A), a plurality of output regions 304 (e.g., comparable to plurality of output regions 204 illustrated in FIG. 2A), and a dispersive region optically disposed between the input region 302 and plurality of output regions 304. The input region 302 and plurality of output regions 304 (e.g., output region 308, output region 310, output region 312, and output region 314) may each be waveguides (e.g., slab waveguide, strip waveguide, slot waveguide, or the like) capable of propagating light along the path of the waveguide. The dispersive region 332 includes a first material and a second material (see, e.g., FIG. 3D) inhomogeneously interspersed to form a plurality of interfaces that each correspond to a change in refractive index of the dispersive region 332 and collectively structure the dispersive region 332 to optically separate each of a plurality of distinct wavelength channels (e.g., Ch. 1, Ch. 2, Ch. 3, . . . Ch. N illustrated in FIG. 2A) from a multi-channel optical signal (e.g., optical signal 110 illustrated in FIG. 2A) and respectively guide each of the plurality of distinct wavelength channels to a corresponding one of the plurality of output regions 304 when the input region 302 receives the multi-channel optical signal. In other words, input region 302 is adapted to receive the multi-channel optical signal including a plurality of distinct wavelength channels and the plurality of output regions 304 are adapted to each receive a corresponding one of the plurality of distinct wavelength channels demultiplexed from the multi-channel optical signal via dispersive region 332.

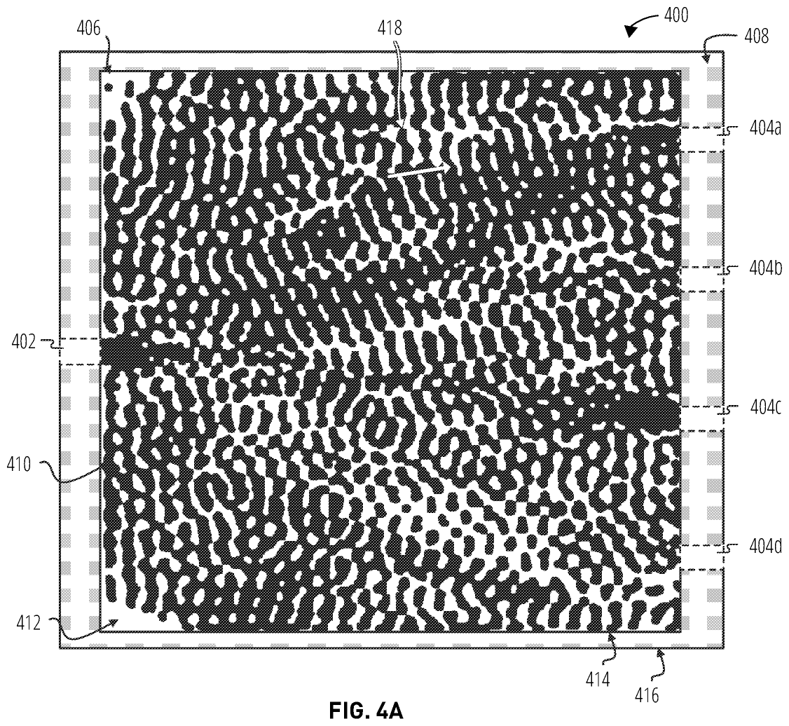

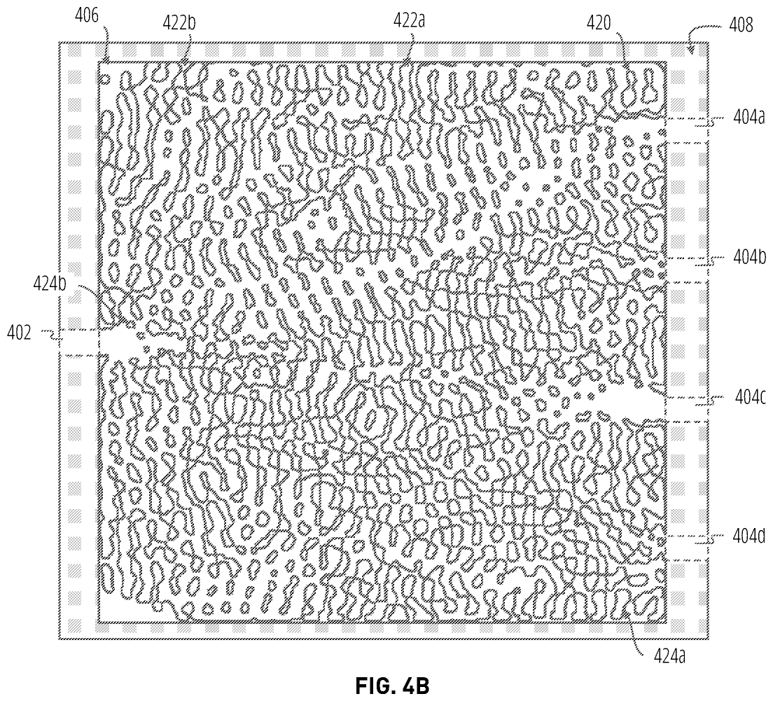

As illustrated in FIG. 3A, and more clearly shown in FIG. 3D and FIG. 4A-FIG. 4B, the shape and arrangement of the first and second material that are inhomogeneously interspersed create a plurality of interfaces that collectively form a material interface pattern along a cross-sectional area of dispersive region 332 that is at least partially surrounded by a periphery region 318 that includes the second material. In some embodiments periphery region 318 has a substantially homogeneous composition that includes the second material. In the illustrated embodiment, dispersive region 332 includes a first side 328 and a second side 330 that each interface with an inner boundary (i.e., the unlabeled dashed line of periphery region 318 disposed between dispersive region 332 and dashed-dotted line corresponding to an outer boundary of periphery region 318). First side 328 and second side 330 are disposed correspond to opposing sides of dispersive region 332. Input region 302 is disposed proximate to first side 328 (e.g., one side of input region 302 abuts first side 328 of dispersive region 332) while each of the plurality of output region 304 are disposed proximate to second side 330 (e.g., one side of each of the plurality of output region 304 abuts second side 330 of dispersive region 332).

In the illustrated embodiment each of the plurality of output regions 304 are parallel to each other one of the plurality of output region 304. However, in other embodiments the plurality of output regions 304 may not be parallel to one another or even disposed on the same side (e.g., one or more of the plurality of output regions 304 and/or input region 302 may be disposed proximate to sides of dispersive region 332 that are adjacent to first side 328 and/or second side 330). In some embodiments adjacent ones of the plurality of output regions are separated from each other by a common separation distance when the plurality of output regions includes at least three output regions. For example, as illustrated adjacent output region 308 and output region 310 are separated from one another by distance 306, which may be common to the separation distance between other pairs of adjacent output regions.

As illustrated in the embodiment of FIG. 3A, demultiplexer 316 includes four output regions 304 (e.g., output region 308, output region 310, output region 312, output region 314) that are each respectively mapped (i.e., by virtue of the structure of dispersive region 332) to a respective one of four channels included in a plurality of distinct wavelength channels. More specifically, the plurality of interfaces of dispersive region 332, defined by the inhomogeneous interspersion of a first material and a second material, form a material interface pattern along a cross-sectional area of the dispersive region 332 (e.g., as illustrated in FIG. 3A, FIG. 4A, or FIG. 4B) to cause the dispersive region 332 to optically separate each of the four channels from the multi-channel optical signal and route each of the four channels to a respective one of the four output regions 304 when the input region 302 regions the multi-channel optical signal.

It is noted that the first material and second material of dispersive region 332 are arranged and shaped within the dispersive region such that the material interface pattern is substantially proportional to a design obtainable with an inverse design process, which will be discussed in greater detail later in the present disclosure. More specifically, in some embodiments, the inverse design process may include iterative gradient-based optimization of a design based at least in part on a loss function that incorporates a performance loss (e.g., to enforce functionality) and a fabrication loss (e.g., to enforce fabricability and binarization of a first material and a second material) that is reduced or otherwise adjusted via iterative gradient-based optimization to generate the design. In the same or other embodiments, other optimization techniques may be used instead of, or jointly with, gradient-based optimization. Advantageously, this allows for optimization of a near unlimited number of design parameters to achieve functionality and performance within a predetermined area that may not have been possible with conventional design techniques.

For example, in one embodiment dispersive region 332 is structured to optically separate each of the four channels from the multi-channel optical signal within a predetermined area of 35 μm×35 μm (e.g., as defined by width 324 and length 326 of dispersive region 332) when the input region 302 receives the multi-channel optical signal. In the same or another embodiment, the dispersive region is structured to accommodate a common bandwidth for each of the four channels, each of the four channels having different center wavelengths. In one embodiment the common bandwidth is approximately 13 nm wide and the different center wavelengths is selected from a group consisting of 1271 nm, 1291 nm, 1311 nm, 1331 nm, 1506 nm, 1514 nm, 1551 nm, and 1571 nm. In some embodiments, the entire structure of demultiplexer 316 (e.g., including input region 302, periphery region 318, dispersive region 332, and plurality of output regions 304) fits within a predetermined area (e.g., as defined by width 320 and length 322). In one embodiment the predetermined area is 35 μm×35 μm. It is appreciated that in other embodiments dispersive region 332 and/or demultiplexer 316 fits within other areas greater than or less than 35 μm×35 μm, which may result in changes to the structure of dispersive region 332 (e.g., the arrangement and shape of the first and second material) and/or other components of demultiplexer 316.

In the same or other embodiments the dispersive region is structured to have a power transmission of −2 dB or greater from the input region 302, through the dispersive region 332, and to the corresponding one of the plurality of output regions 304 for a given wavelength within one of the plurality of distinct wavelength channels. For example, if channel 1 of a multi-channel optical signal is mapped to output region 308, then when demultiplexer 316 receives the multi-channel optical signal at input region 302 the dispersive region 332 will optically separate channel 1 from the multi-channel optical signal and guide a portion of the multi-channel optical signal corresponding to channel 1 to output region 308 with a power transmission of −2 dB or greater. In the same or another embodiment, dispersive region 332 is structured such that an adverse power transmission (i.e., isolation) for the given wavelength from the input region to any of the plurality of output regions other than the corresponding one of the plurality of output regions is −30 dB or less, −22 dB or less, or otherwise. For example, if channel 1 of a multi-channel optical signal is mapped to output region 308, then the adverse power transmission from input region 302 to any other one of the plurality of output regions (e.g., output region 310, output region 312, output region 314) other than the corresponding one of the plurality of output regions (e.g., output region 308) is −30 dB or less, −22 dB or less, or otherwise. In some embodiments, a maximum power reflection from demultiplexer 316 of an input signal (e.g., a multi-channel optical signal) received at an input region (e.g., input region 302) is reflected back to the input region by dispersive region 332 or otherwise is −40 dB or less, −20 dB or less, −8 dB or less, or otherwise. It is appreciated that in other embodiments the power transmission, adverse power transmission, maximum power, or other performance characteristics may be different than the respective values discussed herein, but the structure of dispersive region 332 may change due to the intrinsic relationship between structure, functionality, and performance of demultiplexer 316.

FIG. 3B illustrates a vertical schematic or stack of various layers that are included in the illustrated embodiment of demultiplexer 316. However, it is appreciated that the illustrated embodiment is not exhaustive and that certain features or elements may be omitted to avoid obscuring certain aspects of the invention. In the illustrated embodiment, demultiplexer 316 includes substrate 334, dielectric layer 336, active layer 338 (e.g., as shown in the cross-sectional illustration of FIG. 3A), and a cladding layer 340. In some embodiments, demultiplexer 316 may be, in part or otherwise, a photonic integrated circuit or silicon photonic device that is compatible with conventional fabrication techniques (e.g., lithographic techniques such as photolithographic, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 334, a silicon dioxide dielectric layer that corresponds to dielectric layer 336, a silicon layer (e.g., intrinsic, doped, or otherwise), and a oxide layer (e.g., intrinsic, grown, or otherwise). In one embodiment, the silicon in the active layer 338 may be etched selectively by lithographically creating a pattern on the SOI wafer that is transferred to SOI wafer via a dry etch process (e.g., via a photoresist mask or other hard mask) to remove portions of the silicon. The silicon may be etched all the way down to dielectric layer 336 to form voids that may subsequently be backfilled with silicon dioxide that is subsequently encapsulated with silicon dioxide to form cladding layer 340. In one embodiment, there may be several etch depths including a full etch depth of the silicon to obtain the targeted structure. In one embodiment, the silicon may be 206 nm thick and thus the full etch depth may be 206 nm. In some embodiments, this may be a two-step encapsulation process in which two silicon dioxide depositions are performed with an intermediate chemical mechanical planarization used to yield a planar surface.

FIG. 3C illustrates a more detailed view of active layer 338 (relative to FIG. 3B) taken along a portion of periphery region 318 that includes input region 302 of FIG. 3A. In the illustrated embodiment, active layer 338 includes a first material 342 with a refractive index of ε₁ and a second material 344 with a refractive index of ε₂ that is different from ε₁. Homogenous regions of the first material 342 and the second material 344 may form waveguides or portions of waveguides that correspond to input region 302 and plurality of output region 304 as illustrated in FIG. 3A and FIG. 3C.

FIG. 3D illustrates a more detailed view of active layer 338 (relative to FIG. 3B) taken along dispersive region 332. As described previously, active layer 338 includes a first material 342 (e.g., silicon) and a second material 344 (e.g., silicon dioxide) that are inhomogeneously interspersed to form a plurality of interfaces 346 that collectively form a material interface pattern. Each of the plurality of interfaces 346 that form the interface pattern correspond to a change in refractive index of dispersive region 332 to structure the dispersive region (i.e., the shape and arrangement of first material 342 and second material 344) to provide, at least in part, the functionality of demultiplexer 316 (i.e., optical separation of the plurality of distinct wavelength channels from the multi-channel optical signal and respective guidance of each of the plurality of distinct wavelength channels to the corresponding one of the plurality of output regions 304 when the input region 302 receives the multi-channel optical signal).

It is appreciated that in the illustrated embodiments of demultiplexer 316 as shown in FIG. 3A-FIG. 3D, the change in refractive index is shown as being vertically consistent (i.e., the first material 342 and second material 344 form interfaces that are substantially vertical or perpendicular to a lateral plane or cross-section of demultiplexer 316. However, in the same or other embodiments, the plurality of interfaces (e.g., interfaces 346 illustrated in FIG. 3D) may not be substantially perpendicular with the lateral plane or cross-section of demultiplexer 316.

FIG. 4A illustrates a more detailed cross-sectional view of a dispersive region of example photonic demultiplexer 400, in accordance with an embodiment of the present disclosure. FIG. 4B illustrates a more detailed view of an interface pattern formed by the shape and arrangement of a first material 410 and a second material 412 for the dispersive region of the photonic demultiplexer 400 of FIG. 4A. Photonic demultiplexer 400 is one possible implementation of MUX/DEMUX 114 illustrated in FIG. 1, demultiplexer 206 illustrated in FIG. 2A, and demultiplexer 316 illustrated in FIG. 3A-FIG. 3D.

As illustrated in FIG. 4A and FIG. 4B, photonic demultiplexer 400 includes an input region 402, a plurality of output regions 404a-404d, and a dispersive region 406 optically disposed between input region 402 and plurality of output regions 404a-404d. Dispersive region 406 is surrounded, at least in part, by a peripheral region 408 that includes an inner boundary 414 and an outer boundary 416. It is appreciated that like named or labeled elements of photonic demultiplexer 400 may similarly correspond to like named or labeled elements of other demultiplexers described in embodiments of the present disclosure.

The first material 410 (i.e., black colored regions within dispersive region 406) and second material 412 (i.e., white colored regions within dispersive region 406) of photonic demultiplexer 400 are inhomogeneously interspersed to create a plurality of interfaces that collectively form material interface pattern 420 as illustrated in FIG. 4B. More specifically, an inverse design process that utilizes iterative gradient-based optimization, Markov Chain Monte Carlo optimization, or other optimization techniques combined with first principles simulations to generate a design that is substantially replicated by dispersive region 406 within a proportional or scaled manner such that photonic demultiplexer 400 provides the desired functionality. In the illustrated embodiment, dispersive region 406 is structured to optically separate each of a plurality of distinct wavelength channels from a multi-channel optical signal and respectively guide each of the plurality of distinct wavelength channels to a corresponding one of the plurality of output regions 404a-404d when the input region 402 receives the multi-channel optical signal. More specifically, the plurality of output regions 404a-404d are respectively mapped to wavelength channels having center wavelengths correspond to 1271 nm, 1291 nm, 1311 nm, and 1331 nm. In another embodiment, output regions 404a-404d are respectfully mapped to wavelength channels having center wavelengths that correspond to 1506 nm, 1514 nm, 1551 nm, and 1571 nm.

As illustrated in FIG. 4B, material interface pattern 420, which is defined by the black lines within dispersive region 406 and corresponds to a change in refractive index within dispersive region 406, includes a plurality of protrusions 422a-422b. A first protrusion 422a is formed of the first material 410 and extends from peripheral region 408 into dispersive region 406. Similarly, a second protrusion 422b is formed of the second material 412 and extends from peripheral region 408 into dispersive region 406. Further illustrated in FIG. 4B, dispersive region 406 includes a plurality of islands 424a-424b formed of either the first material 410 or the second material 412. The plurality of islands 424a-424b include a first island 424a that is formed of the first material 410 and is surrounded by the second material 412. The plurality of islands 424a-424b also includes a second island 424b that is formed of the second material 412 and is surrounded by the first material 410.

In some embodiments, material interface pattern 420 includes one or more dendritic shapes, wherein each of the one or more dendritic shapes are defined as a branched structure formed from first material 410 or second material 412 and having a width that alternates between increasing and decreasing in size along a corresponding direction. Referring back to FIG. 4A, for clarity, dendritic structure 418 is labeled with a white arrow having a black border. As can be seen, the width of dendritic structure 418 alternatively increases and decreases in size along a corresponding direction (i.e., the white labeled arrow overlaying a length of dendritic structure 418) to create a branched structure. It is appreciated that in other embodiments there may be no protrusions, there may be no islands, there may be no dendritic structures, or there may be any number, including zero, of protrusions, islands of any material included in the dispersive region 406, dendritic structures, or a combination thereof.

In some embodiments, the inverse design process includes a fabrication loss that enforces a minimum feature size, for example, to ensure fabricability of the design. In the illustrated embodiment of photonic demultiplexer 400 illustrated in FIG. 4A and FIG. 4B, material interface pattern 420 is shaped to enforce a minimum feature size within dispersive region 406 such that the plurality of interfaces within the cross-sectional area formed with first material 410 and second material 412 do not have a radius of curvature with a magnitude of less than a threshold size. For example, if the minimum feature size is 150 nm, the curvature for any of the plurality of interfaces have a magnitude of less than the threshold size, which corresponds to the inverse of half the minimum feature size (i.e., 1/75 nm⁻¹). Enforcement of such a minimum feature size prevents the inverse design process from generating designs that are not fabricable by considering manufacturing constraints, limitations, and/or yield. In the same or other embodiments, different or additional checks on metrics related to fabricability may be utilized to enforce a minimum width or spacing as a minimum feature size.

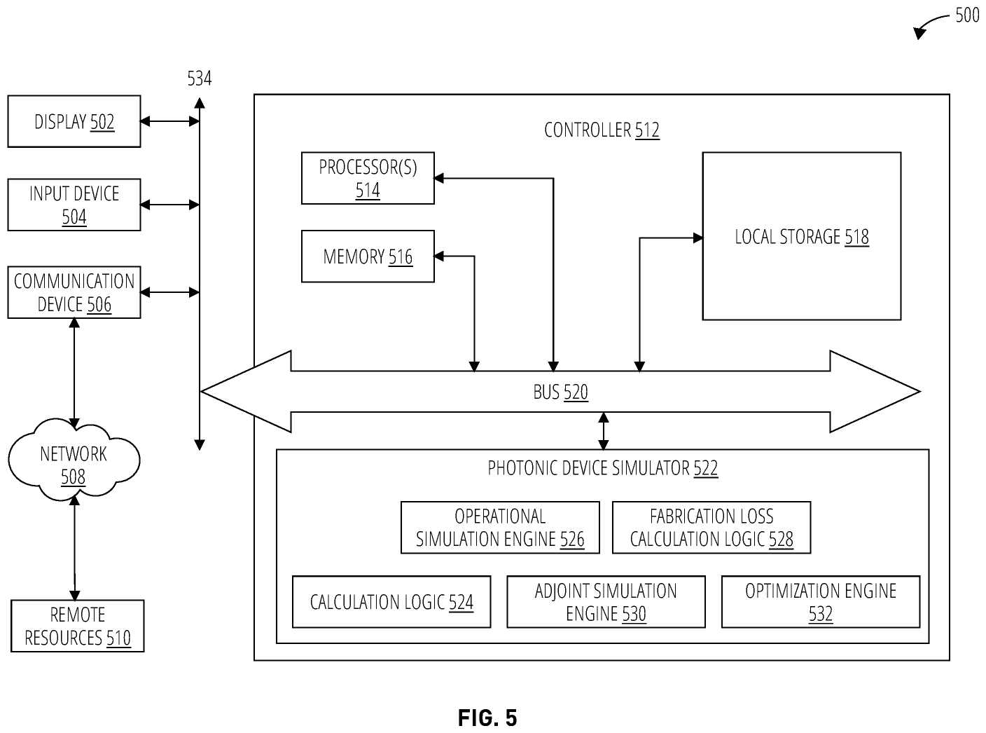

FIG. 5 is a functional block diagram illustrating a system 500 for generating a design of a photonic integrated circuit (i.e., photonic device), in accordance with an embodiment of the disclosure. System 500 may be utilized to perform an inverse design process that generates a design with iterative gradient-based optimization that takes into consideration the underlying physics that govern the operation of the photonic integrated circuit. More specifically, system 500 is a design tool that may be utilized to optimize structural parameters (e.g., shape and arrangement of a first material and a second material within the dispersive region of the embodiments described in the present disclosure) of photonic integrated circuits based on first-principles simulations (e.g., electromagnetic simulations to determine a field response of the photonic device to an excitation source) and iterative gradient-based optimization. In other words, system 500 may provide a design obtained via the inverse design process that is substantially replicated (i.e., proportionally scaled) by dispersive region 332 and dispersive region 406 of demultiplexer 316 and photonic demultiplexer 400 illustrated in FIG. 3A and FIG. 4A, respectively.

As illustrated, system 500 includes controller 512, display 502, input device(s) 504, communication device(s) 506, network 508, remote resources 510, bus 534, and bus 520. Controller 512 includes processor 514, memory 516, local storage 518, and photonic device simulator 522. Photonic device simulator 522 includes operational simulation engine 526, fabrication loss calculation logic 528, calculation logic 524, adjoint simulation engine 530, and optimization engine 532. It is appreciated that in some embodiments, controller 512 may be a distributed system.

Controller 512 is coupled to display 502 (e.g., a light emitting diode display, a liquid crystal display, and the like) coupled to bus 534 through bus 520 for displaying information to a user utilizing system 500 to optimize structural parameters of the photonic device (i.e., demultiplexer). Input device 504 is coupled to bus 534 through bus 520 for communicating information and command selections to processor 514. Input device 504 may include a mouse, trackball, keyboard, stylus, or other computer peripheral, to facilitate an interaction between the user and controller 512. In response, controller 512 may provide verification of the interaction through display 502.

Another device, which may optionally be coupled to controller 512, is one or more communication device(s) 506 for accessing remote resources 510 of a distributed system via network 508. Communication device 506 may include any of a number of networking peripheral devices such as those used for coupling to an Ethernet, Internet, or wide area network, and the like. Communication device 506 may further include a mechanism that provides connectivity between controller 512 and the outside world. Note that any or all of the components of system 500 illustrated in FIG. 5 and associated hardware may be used in various embodiments of the present disclosure. The remote resources 510 may be part of a distributed system and include any number of processors, memory, and other resources for optimizing the structural parameters of the photonic device.

Controller 512 orchestrates operation of system 500 for optimizing structural parameters of the photonic device. Processor 514 (e.g., one or more central processing units, graphics processing units, and/or tensor processing units, etc.), memory 516 (e.g., volatile memory such as DRAM and SRAM, non-volatile memory such as ROM, flash memory, and the like), local storage 518 (e.g., magnetic memory such as computer disk drives), and the photonic device simulator 522 are coupled to each other through bus 520. Controller 512 includes software (e.g., instructions included in memory 516 coupled to processor 514) and/or hardware logic (e.g., application specific integrated circuits, field-programmable gate arrays, and the like) that when executed by controller 512 causes controller 512 or system 500 to perform operations. The operations may be based on instructions stored within any one of, or a combination of, memory 516, local storage 518, physical device simulator 522, and remote resources 510 accessed through network 508.

In the illustrated embodiment, the components of photonic device simulator 522 are utilized to optimize structural parameters of the photonic device (e.g., MUX/DEMUX 114 of FIG. 1, demultiplexer 206 of FIG. 2A, multiplexer 208 of FIG. 2B, demultiplexer 316 of FIG. 3A-FIG. 3D, and photonic demultiplexer 400 of FIG. 4A-FIG. 4B). In some embodiments, system 500 may optimize the structural parameters of the photonic device via, inter alia, simulations (e.g., operational and adjoint simulations) that utilize a finite-difference time-domain (FDTD) method, a finite-difference frequency-domain (FDFD) method, or any other suitable technique to model the field response (e.g., electric and magnetic fields within the photonic device). The operational simulation engine 526 provides instructions for performing an electromagnetic simulation of the photonic device operating in response to an excitation source within a virtual prototype. In particular, the operational simulation determines a field response of the virtual prototype (and thus the photonic device, which is described by the virtual prototype) in response to the excitation source for determining a performance metric of the physical device (e.g., based off an initial description or input design of the photonic device that describes the structural parameters of the photonic device within the virtual prototype with a plurality of voxels). The structural parameters may correspond, for example, to the specific design, material compositions, dimensions, and the like of the physical device. Fabrication loss calculation logic 528 provides instructions for determining a fabrication loss, which is utilized to enforce a minimum feature size to ensure fabricability. In some embodiments, the fabrication loss is also used to enforce binarization of the design (i.e., such that the photonic device includes a first material and a second material that are interspersed to form a plurality of interfaces). Calculation logic 524 computes a loss metric determined via a loss function that incorporates a performance loss, based on the performance metric, and the fabrication loss. Adjoint simulation engine 530 is utilized in conjunction with the operational simulation engine 526 to perform an adjoint simulation of the photonic device to backpropagate the loss metric through the virtual prototype via the loss function to determine how changes in the structural parameters of the photonic device influence the loss metric (i.e., the gradient of the loss function with respect to the structural parameters, otherwise known as a sensitivity map). Optimization engine 532 is utilized to update the structural parameters of the photonic device to reduce the loss metric and generate a revised description (i.e., revising the design) of the photonic device.

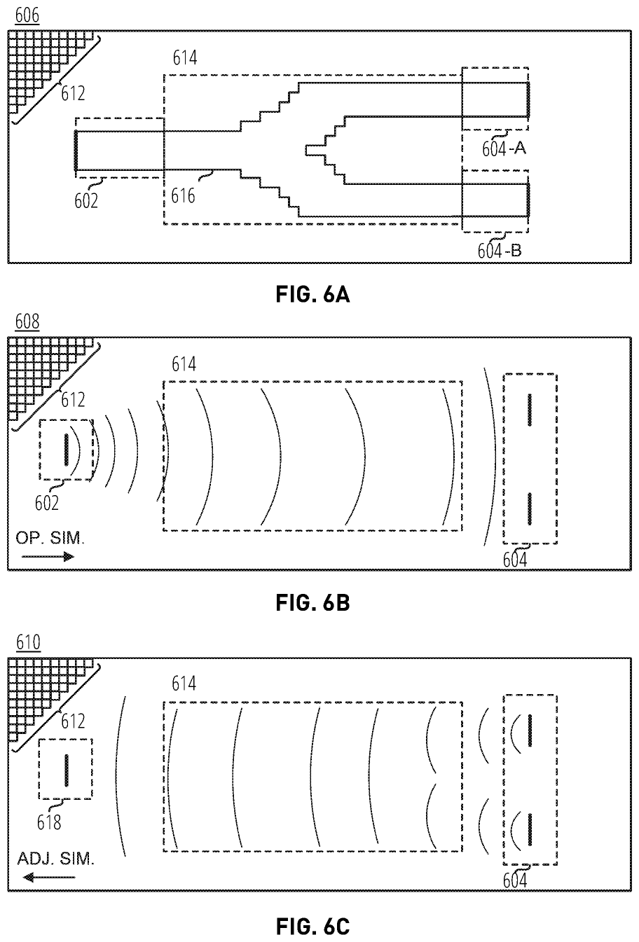

FIG. 6A-FIG. 6C respectively illustrate non-limiting example embodiments of an initial set up of a virtual prototype 606 describing a photonic device, performing an operational simulation of the photonic device in response to an excitation source within the virtual prototype 608, and performing an adjoint simulation of the photonic device within the virtual prototype 610 according to various aspects of the present disclosure. The initial set up of the virtual prototype, 2-dimensional representation of the virtual prototype, operational simulation of the physical device, and adjoint simulation of the physical device may be implemented with system 500 illustrated in FIG. 5.

As illustrated in FIG. 6A-FIG. 6C, the virtual prototype is represented in two dimensions. However, it is appreciated that other dimensionality (e.g., 3-dimensional space) may also be used to describe the virtual prototype and the photonic device. In some embodiments, optimization of structural parameters of the photonic device illustrated in FIG. 6A-FIG. 6C may be achieved via an inverse design process including, inter alia, simulations (e.g., operational simulations and adjoint simulations) that utilize a finite-difference time-domain (FDTD) method, a finite-difference frequency-domain (FDFD) method, or any other suitable technique to model the field response (e.g., electric and magnetic field) to an excitation source.

FIG. 6A illustrates a demonstrative virtual prototype 606 describing a photonic integrated circuit (i.e., a photonic device such as a waveguide, demultiplexer, and the like), in accordance with a non-limiting example embodiment of the present disclosure. More specifically, in response to receiving an initial description of a photonic device defined by one or more structural parameters (e.g., an input design), a system (e.g., system 500 of FIG. 5) configures a virtual prototype 606 to be representative of the photonic device. As illustrated, the virtual prototype 606 (and subsequently the photonic device) is described by a plurality of voxels 612, which represent individual elements (i.e., discretized) of the two-dimensional (or other dimensionality) space. Each of the voxels 612 is illustrated as a two-dimensional square; however, it is appreciated that the voxel may be represented as cubes or other shapes in three-dimensional space. It is appreciated that the specific shape and dimensionality of the plurality of voxels 612 may be adjusted dependent on the virtual prototype 606 and photonic device being simulated. It is further noted that only a portion of the plurality of voxels 612 are illustrated to avoid obscuring other aspects of the virtual prototype 606.

Each of the plurality of voxels 612 may be associated with a structural value, a field value, and a source value. Collectively, the structural values of the virtual prototype 606 describe the structural parameters of the photonic device. In one embodiment, the structural values may correspond to a relative permittivity, permeability, and/or refractive index that collectively describe structural (i.e., material) boundaries or interfaces of the photonic device (e.g., material interface pattern 420 of FIG. 4B). For example, an interface 616 is representative of where relative permittivity changes within the virtual prototype 606 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxels 612. Thus, the field response may be based, at least in part, on the structural parameters of the photonic device and the excitation source.

In the illustrated embodiment, the photonic device corresponds to an optical demultiplexer having a design region 614 (e.g., corresponding to dispersive region 332 of FIG. 3A, and/or dispersive region 406 of FIG. 4A), in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 602 to a corresponding one of the output ports 604. Thus, input port 602 (e.g., corresponding to input region 302 of FIG. 3A, input region 402 of FIG. 4A, and the like) of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within virtual prototype 606). In other words, the excitation source may cause the field response of the photonic device to change, which is dependent on the underlying physics governing the physical domain and the structural parameters of the photonic device. The excitation source originates or is otherwise proximate to input port 602 and is positioned to propagate (or otherwise influence the field value of the plurality of voxel) through the design region 614 towards output ports 604 of the photonic device. In the illustrated embodiment, the input port 602 and output ports 604 are positioned outside of the design region 614. In other words, in the illustrated embodiment, only a portion of the structural parameters of the photonic device is optimizable.

However, in other embodiments, the entirety of the photonic device may be placed within the design region 614 such that the structural parameters may represent any portion or the entirety of the design of the photonic device. The electric and magnetic fields within the virtual prototype 606 (and subsequently the photonic device) may change (e.g., represented by the field value of the individual voxel that collectively correspond to the field response of the virtual prototype) in response to the excitation source. The output ports 604 of the optical demultiplexer may be used for determining a performance metric of the photonic device in response to the excitation source (e.g., power transmission from input port 602 to a specific one of the output ports 604). The initial description of the photonic device, including initial structural parameters, excitation sources, performance parameters or metrics, and other parameters describing the photonic device, are received by the system (e.g., system 500 of FIG. 5) and used to configure the virtual prototype 606 for performing a first-principles based simulation of the photonic device. These specific values and parameters may be defined directly by a user (e.g., of system 500 in FIG. 5), indirectly (e.g., via controller 512 culling pre-determined values stored in memory 516, local storage 518, or remote resources 510), or a combination thereof.

FIG. 6B illustrates a non-limiting example embodiment of an operational simulation of the photonic device in response to an excitation source within the virtual prototype 608, in accordance with various aspects of the present disclosure. In the illustrated embodiment, the photonic device is an optical demultiplexer structured to optically separate each of a plurality of distinct wavelength channels included in a multi-channel optical signal received at input port 602 and respectively guide each of the plurality of distinct wavelength channels to a corresponding one of the plurality of output ports 604. The excitation source may be selected (randomly or otherwise) from the plurality of distinct wavelength channels and originates at input port 602 having a specified spatial, phase, and/or temporal profile. The operational simulation occurs over a plurality of time steps, including the illustrated time step. When performing the operational simulation, changes to the field response (e.g., the field value) for each of the plurality of voxels 612 are incrementally updated in response to the excitation source over the plurality of time steps. The changes in the field response at a particular time step are based, at least in part, on the structural parameters, the excitation source, and the field response of the virtual prototype 610 at the immediately prior time step included in the plurality of time steps. Similarly, in some embodiments the source value of the plurality of voxels 612 is updated (e.g., based on the spatial profile and/or temporal profile describing the excitation source). It is appreciated that the operational simulation is incremental and that the field values (and source values) of the virtual prototype 610 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In one embodiment, the performance metric corresponds to the power transmission at a corresponding one of the output ports 604 mapped to the distinct wavelength channel being simulated by the excitation source. In other words, in some embodiments, the performance metric represents power (at one or more frequencies of interest) in the target mode shape at the specific locations of the output ports 604. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric may be further based on a fabrication loss value that is utilized to enforce a minimum feature size of the photonic device to promote fabricability of the device, and/or other loss values.

FIG. 6C illustrates a non-limiting example embodiment of an adjoint simulation within the virtual prototype 610 by backpropagating a loss metric, in accordance with various aspects of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 604) or other location that corresponds to a location used when determining the performance metric. The adjoint source(s) is then treated as a physical stimuli or an excitation source during the adjoint simulation. A loss response of the virtual prototype 608 is computed for each of the plurality of time steps (e.g., backwards in time) in response to the adjoint source. The loss response collectively refers to loss values of the plurality of voxels 612 that are incrementally updated in response to the adjoint source over the plurality of time steps. The change in loss response based on the loss metric may correspond to a loss gradient, which is indicative of how changes in the field response of the physical device influence the loss metric. The fields computed in response to the adjoint source are combined with the fields from the operational simulation to obtain a structural gradient of the photonic device/virtual prototype (e.g., how changes in the structural parameters of the photonic device within the virtual prototype influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performed while maintaining fabricability.

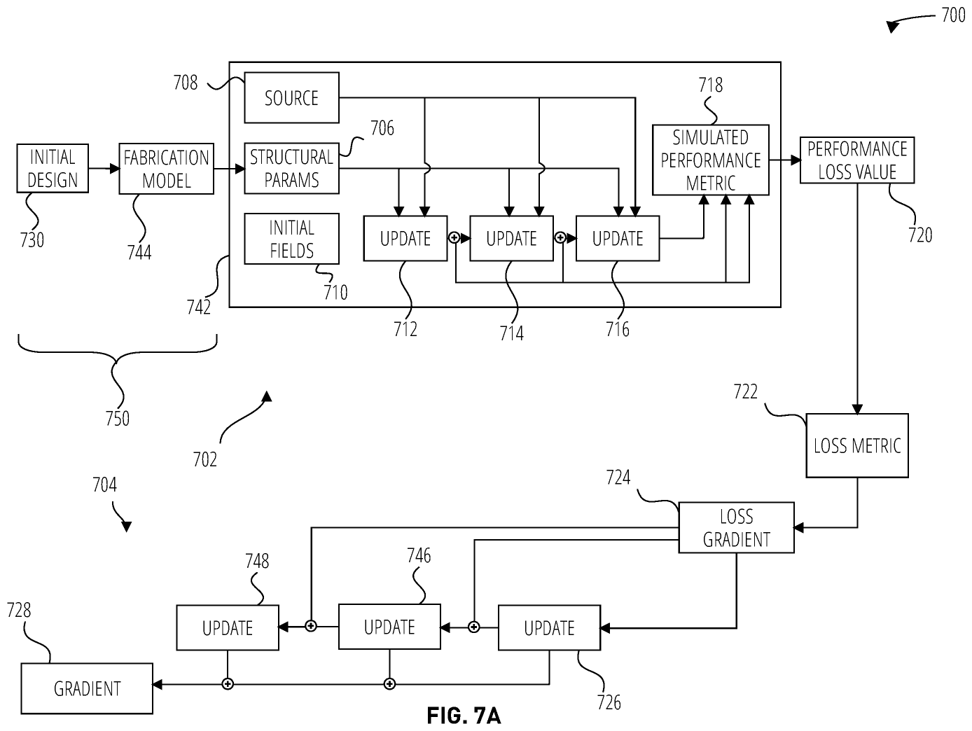

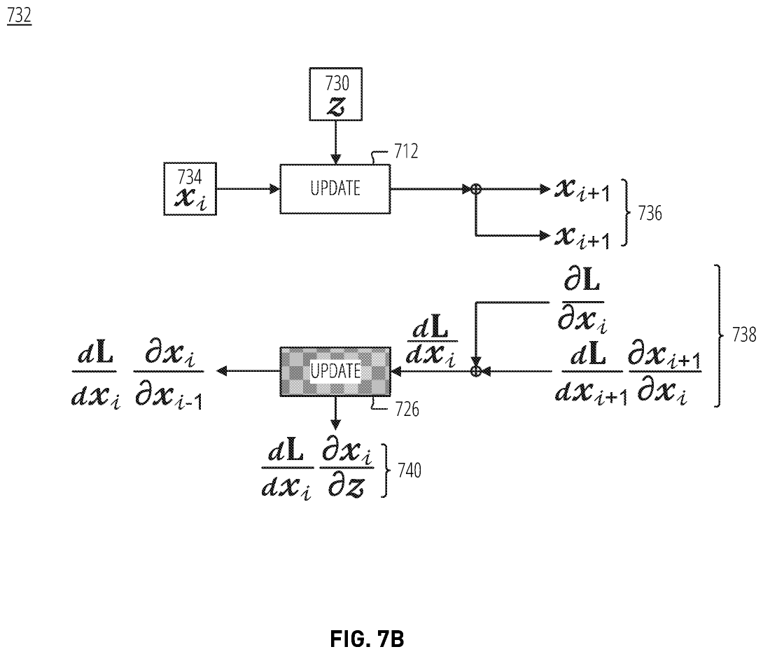

FIG. 7A is a flow chart 700 illustrating example time steps for an operational simulation 702 and an adjoint simulation 704, in accordance with various aspects of the present disclosure. Flow chart 700 is one possible implementation that a system may use to perform the operational simulation 702 and adjoint simulation 704 of the virtual prototype describing a photonic integrated circuit (e.g., an optical device operating in an electromagnetic domain such as a photonic demultiplexer). In the illustrated embodiment, the operational simulation 702 utilizes a technique such as a finite-difference time-domain (FDTD) method or a finite-difference frequency-domain (FDFD) method to model the field response (both electric and magnetic) or loss response at each of a plurality of voxels for a plurality of time steps in response to physical stimuli corresponding to an excitation source and/or adjoint source. In some embodiments, a fabrication model may be used to improve the accuracy of the simulation by converting a nominal design to a structural parameter that more closely matches an actual physical device as it would be fabricated by a given fabrication system given the nominal design.

As illustrated in FIG. 7A, the operational simulation 702 includes a configuration portion 750 and a simulation portion 742. In the configuration portion 750, an initial design 730 is received that includes structural parameters for a physical device such as a photonic device to be simulated. In some embodiments, the initial design 730 may also include additional or different information regarding the design, including but not limited to a linear function to define the structural parameters (instead of the structural parameters themselves), desired performance values, a performance loss function to be used to compare simulated performance to desired performance, or other information.

After receiving the initial design 730, the operational simulation 702 uses a fabrication model 744 to simulate the fabrication of the photonic device based on the initial structural parameters of the initial design 730 to create structural parameters 706 to be simulated in the simulation portion 742. In some embodiments, the fabrication model 744 is a sequence of differentiable operations that embodies differences from the initial design 730 that will be introduced by a fabrication system during fabrication. In some embodiments, instead of a sequence of differentiable operations, the fabrication model 744 may be represented by a neural network. Parameters for the fabrication model 744 may be learned using an optimization process as described in further detail below.

After the structural parameters 706 are determined using the fabrication model 744, the operational simulation 702 proceeds to a simulation portion 742. The simulation portion 742 occurs over a plurality of time-steps (e.g., from an initial time step to a final time step over a pre-determined or conditional number of time steps having a specified time step size) and models changes (e.g., from the initial field value 710) in electric and magnetic fields of a plurality of voxels describing the virtual prototype and/or photonic device that collectively correspond to the field response. More specifically, update operations (e.g., update operation 712, update operation 714, and update operation 716) are iterative and based on the field response, structural parameters 706, and one or more excitation sources 708. Each update operation is succeeded by another update operation, which are representative of successive steps forward in time within the plurality of time steps. For example, update operation 714 updates the field values 734 (see, e.g., FIG. 7B) based on the field response determined from the previous update operation 712, excitation sources 708, and the structural parameters 706. Similarly, update operation 716 updates the field values 736 (see, e.g., FIG. 7B) based on the field response determined from update operation 714. In other words, at each time step of the operational simulation 702 the field values (and thus field response) are updated based on the previous field response and structural parameters of the photonic device.

Once the final time step of the simulation portion 742 is performed (although three update operations are illustrated for the sake of clarity and brevity, in some embodiments more than three update operations are performed), a simulated performance metric 718 is used to determine a performance loss value 720 associated with the structural parameters 706. In some embodiments, the simulated performance metric 718 is a characterization of the performance of the simulated device at one or more points (e.g., at the output ports of the device) and at one or more bandwidths, similar to the illustration in FIG. 2C, and the performance loss value 720 may include a comparison of the simulated performance metric 718 to a desired performance metric. The performance loss value 720 can then be used to determine (or used as) a loss metric 722. In some embodiments, the performance loss value 720 or loss metric 722 may include multiple values for multiple aspects of performance (e.g., for separate output ports).

From the loss metric 722, a loss gradient 724 may be determined. The loss gradient 724 may be treated as adjoint or virtual sources (e.g., physical stimuli or excitation source originating at an output region or port) which are backpropagated in reverse (from the final time step incrementally through the plurality of time steps until reaching the initial time step via update operation 726, update operation 746, and update operation 748) to determine gradient 728. Because it is determined based on the simulated performance metric 718, the gradient 728 is associated with the initial design 730 as modified by the fabrication model 744.

In the illustrated embodiment, the FDTD solve (e.g., simulation portion 742 of the operational simulation 702) and backward solve (e.g., adjoint simulation 704) problem are described pictorially, from a high-level, using only “update” and “loss” operations as well as their corresponding gradient operations. The simulation is set up initially in which the structural parameters, physical stimuli (i.e., excitation sources), and initial field states of the virtual prototype (and photonic device) are provided (e.g., via an initial description and/or input design). As discussed previously, the field values are updated in response to the excitation sources based on the structural parameters. More specifically, the update operation is given by ϕ, where [symbol] =ϕ [symbol] [symbol] [symbol] ) for [symbol] =1, . . . , [symbol] . Here, [symbol] corresponds to the total number of time steps (e.g., the plurality of time steps) for the operational simulation, where [symbol] corresponds to the field response (the field value associated with the electric and magnetic fields of each of the plurality of voxels) of the virtual prototype at time step [symbol] , [symbol] corresponds to the excitation source(s) (the source value associated with the electric and magnetic fields for each of the plurality of voxels) of the virtual prototype at time step [symbol] , and [symbol] corresponds to the structural parameters describing the topology and/or material properties of the physical device (e.g., relative permittivity, index of refraction, and the like).

It is noted that using the FDTD method, the update operation may specifically be stated as:

ϕ( [symbol] , [symbol] , [symbol] )=A( [symbol] ) [symbol] +B( [symbol] )

[symbol]

That is to say the FDTD update is linear with respect to the field and source terms. Concretely, A( [symbol] )∈ [symbol] ^{N×N} and B( [symbol] )∈ [symbol] ^{N×N} are linear operators which depend on the structural parameters, [symbol] , and act on the fields, [symbol] and the sources, [symbol] , respectively. Here, it is assumed that [symbol] , [symbol] where N is the number of FDTD field components in the operational simulation. Additionally, the loss operation (e.g., loss function) may be given by L=ƒ( [symbol] . . . , [symbol] , which takes as input the computed fields and produces a single, real-valued scalar (e.g., the loss metric) that can be reduced and/or minimized.

In terms of revising or otherwise optimizing the structural parameters of the physical device, the relevant quantity to produce is dL/ [symbol] , which is used to describe the influence of changes in the structural parameters of the initial design 730 on the loss value and is denoted as the gradient 728 illustrated in FIG. 7A.

FIG. 7B is a chart 732 illustrating the relationship between the update operation for the operational simulation and the adjoint simulation (e.g., backpropagation), in accordance with an embodiment of the present disclosure. More specifically, FIG. 7B summarizes the operational and adjoint simulation relationships that are involved in computing the structural gradient dL/ [symbol] , which include ∂/ [symbol] , [symbol] / [symbol] , dL/ [symbol] , and [symbol] / [symbol] . The update operation 714 of the operational simulation 702 updates the field values 734, [symbol] , of the plurality of voxels at the [symbol] th time step to the next time step (i.e., [symbol] +1 time step), which correspond to the field values 736, [symbol] . The gradients 738 are utilized to determine ∂L/ [symbol] for the backpropagation (e.g., update operation 726 backwards in time), which combined with the gradients are used, at least in part, to calculate the structural gradient,

$$\frac{d L}{d z} . \frac{\partial L}{\partial {x}_{i}}$$

is the contribution of each field to the loss metric, L. It is noted that this is the partial derivative, and therefore does not take into account the causal relationship of [symbol] ∛ [symbol] Thus, [symbol] / [symbol] is utilized which encompasses the [symbol] → [symbol] relationship. The loss gradient, dL/ [symbol] may also be used to compute the structural gradient, dL/ [symbol] and corresponds to the total derivative of the field with respect to loss value, L. The loss gradient, dL/ [symbol] at a particular time step, i, is equal to the summation of

$$\frac{\partial L}{\partial {x}_{\dot{ι}}} + \frac{d L}{d {x}_{x + 1}} \frac{\partial {x}_{í + 1}}{\partial {x}_{i}} .$$

Finally, [symbol] / [symbol] , which corresponds to the field gradient, is used which is the contribution to dL/ [symbol] from each time/update step.

In particular, the memory footprint to directly compute ∂L/ [symbol] and dL/ [symbol] so large that it is difficult to store more than a handful of state Tensors. The state Tensor corresponds to storing the values of all of the FDTD cells (e.g., the plurality of voxels) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be necessary to store the fields, [symbol] for all time steps, [symbol] . This is because, for most choices of ƒ, the gradient will be a function of the arguments of ƒ. This difficulty is compounded by the fact that the values of ∂L/ [symbol] for larger values of [symbol] are needed before the values for smaller [symbol] due to the incremental updates of the field response and/or through backpropagation of the loss metric, which may prevent the use of schemes that attempt to store only the values ∂L/ [symbol] , at an immediate time step.

An additional difficulty is further illustrated when computing the structural gradient, dL/ [symbol] , which is given by:

$$\frac{d L}{d z} = {\sum }_{i} \frac{d L}{d {x}_{i}} \frac{\partial {x}_{i}}{\partial z} .$$

For completeness, the full form of the first term in the sum, dL/ [symbol] , is expressed as:

$$\frac{d L}{d {x}_{i}} = \frac{\partial L}{\partial x} + \frac{d L}{d {x}_{i + 1}} \frac{\partial {x}_{i + 1}}{\partial {x}_{i}}$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 726), which can be expressed as:

$$\frac{d L}{d {x}_{i}} = \frac{\partial L}{\partial {x}_{i}} + \frac{d L}{d {x}_{i + 1}} A ( z ) , or$$

$${∇}_{{x}_{i}} L = {A ( z )}^{T} {∇}_{{x}_{i + 1}} L + \frac{\partial {L}^{T}}{\partial {x}_{i}}$$

The adjoint update is the backpropagation of the loss gradient (e.g., from the loss metric) from later to earlier time steps and may be referred to as a backwards solve for dL/ [symbol] . More specifically, the loss gradient may initially be based upon the backpropagation of a loss metric determined from the operational simulation with the loss function. The second term in the sum of the structural gradient, dL/ [symbol] , corresponds to the field gradient and is denoted as:

$$\frac{\partial {x}_{i}}{\partial z} = \frac{d ϕ ( {x}_{i - 1} , {i - 1}_{} , z )}{dz} = \frac{dA ( z )}{dz} {x}_{i - 1} + \frac{d B ( z )}{dz} {i - 1}_{} ,$$

for the particular form of ϕ described by the first equation above. Thus, each term of the sum associated with dL/ [symbol] depends on both dL/ [symbol] for [symbol] >= [symbol] and [symbol] for [symbol] < [symbol] . Since the dependency chains of these two terms are in opposite directions, it is concluded that computing dL/ [symbol] in this way requires the storage of [symbol] values for all of [symbol] . In some embodiments, the need to store all field value may be mitigated by a reduced representation of the fields.

Returning to FIG. 7A, the operational simulation 702 and adjoint simulation 704 as described above are used to optimize the initial design 730 with respect to a loss metric 722 that would typically represent a desired performance of the physical device.

As recognized above, one problem in designing physical devices such as the photonic devices described above is that fabrication systems generally do not produce photonic devices that have the precise structure that is simulated using the techniques described above. The fabrication of photonic devices using fabrication systems such as semiconductor foundries involves a complex, multi-stage process of transferring the design from a photomask to a silicon wafer. Despite pre-corrections made to the photomask to compensate for distortion effects introduced by the photolithography process, the fabricated physical device still may exhibit shape distortions including but not limited to rounding of sharp corners, erosion or dilation of shape contours, oblique sidewall angles, and non-uniform layer thicknesses. These distortions are due to statistical variations of semiconductor processing and can affect performance of the manufactured physical devices in unexpected ways, given the delicate wave-interference physics which underlies the performance of physical devices such as the photonic devices described herein.

Characterizing these non-uniformities is a priority for operators of fabrication systems. A process design kit (PDK) provided by a given fabrication system/foundry typically includes specifications and tolerances for critical features sizes such as the minimum line width and spacing, curvature, as well as minimum area (e.g, islands) and enclosed area (e.g., holes). However, the detailed processing capability including the optical proximity correction (OPC) and yields of a given foundry node are trade secrets, and are not generally available during the design process of the physical device to be fabricated. To ensure reliable and consistent manufacturing of inverse-designed physical devices, it is desirable to know a priori what the manufactured structure in the silicon wafer will be for a given photomask/design. It is further desirable for this information to be available without any detailed knowledge of the capabilities of the fabrication system beyond what is made publicly available (e.g., as part of the PDK).

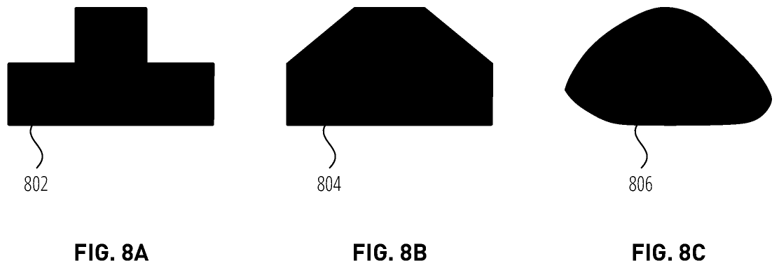

Once a characterization of the non-uniformities is available, a fabrication model (such as the fabrication model 744 illustrated as being used in the flow chart 700) can be created and used to improve the inverse design process of physical devices by increasing the accuracy of the simulated performance metric. FIG. 8A-FIG. 8C illustrate a non-limiting example embodiment of generating predicted structural parameters using a fabrication model according to various aspects of the present disclosure.

FIG. 8A shows an initial design feature 802 that may be provided as a portion of an initial design. The initial design feature 802 shown is an island (such as islands 424a, 424b illustrated and discussed above) for the sake of clarity of the description, though it should be noted that other features of the initial design will experience similar issues. The initial design feature 802 includes sharp edges and corners that may be difficult for the fabrication system to duplicate.

FIG. 8B shows a structural parameter feature 804 generated by the fabrication model based on the initial design feature 802. The fabrication model includes a representation of processes within the fabrication system that make it difficult to accurately reproduce the stepped shape illustrated in FIG. 8A, and so the stepped shape is replaced by angles in the structural parameter feature 804 generated by the fabrication model.

FIG. 8C shows the fabricated feature 806 in an actual fabricated physical device. As seen, while the structural parameter feature 804 may be more similar in shape to the fabricated feature 806 than the initial design feature 802, there are still noticeable differences between the structural parameter feature 804 and the fabricated feature 806. For example, the edges of the fabricated feature 806 are not as well-defined as the edges in the structural parameter feature 804 or the initial design feature 802.

Even though there are some differences between the structural parameter feature 804 and the fabricated feature 806, the generation of the structural parameter feature 804 nevertheless leads to more accurate simulation results, and thus more effective optimization of the design of the physical device.

One difficulty in using fabrication models in optimization processes such as the one illustrated in the flow chart 700 is that fabrication models may not be differentiable or may be poorly differentiable. This leads to difficulties during the backpropagation of the gradients. Specifically, in the operational simulation 702, a composition of functions is applied in the fabrication model used to generate the structural parameters 706 (a first function), and then the structural parameters 706 are used in the simulation to generate the performance loss value 720 (a second function). In order to successfully backpropagate the gradients of these composed functions, the gradients of the functions may be applied separately according to the chain rule. However, if the fabrication model is not differentiable or is poorly differentiable, application of its gradient will lead to poor optimization results due to slow convergence.

As one non-limiting example, a fabrication model may include a term such as:

tanh(β*conv(x,filter))

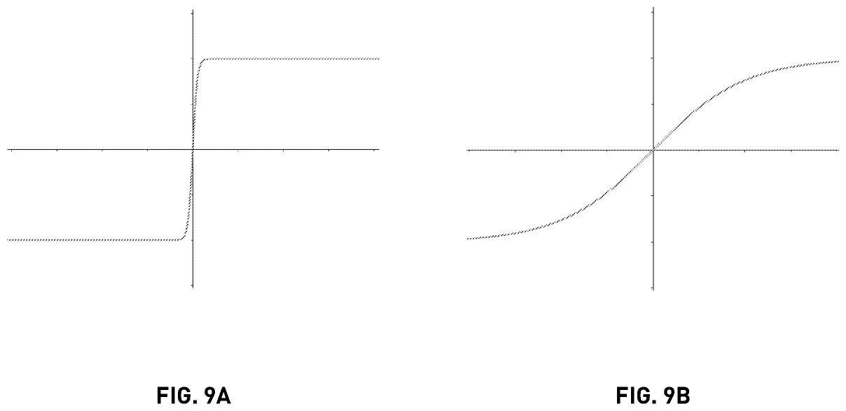

In other words, the fabrication model may include a hyperbolic tangent function that is executed over the product of a beta parameter (β) and a convolutional filter applied to the structural parameters (x). Depending on the value of the beta parameter, this gradient of this function is more or less useful for optimization. FIG. 9A is a chart that illustrates a non-limiting example of this fabrication model with a first value for the beta parameter, and FIG. 9B is a chart that illustrates a non-limiting example of this fabrication model with a second value for the beta parameter.

As seen in FIG. 9A, a large value (e.g., 20) is used for the beta parameter. This large value allows the fabrication model to be used in a forward pass to generate the structural parameters—by having a narrow range of x-axis values that are not close to 1 or −1, the fabrication model can output structural parameters that are mostly highly confident that a given material is either present or absent in a given voxel. However, since the gradient of this function is zero in most places, using the gradient of the function with this large beta parameter will not be effective to optimize the loss metric 722.

FIG. 9B, in contrast, illustrates a small value (e.g., 1) being used for the beta parameter. This small value may be used for the estimator in a backpropagation pass to update the fabrication model—by having a large range of x-axis values that are relatively far from 1 or −1, the gradient of the estimator is non-zero over a wider range of values, and is therefore can be used for optimization.

What is desired are optimization techniques that can use an estimator for the gradient of the fabrication model instead of an actual gradient of the fabrication model, and thus provide successful optimization through backpropagation of gradients even when the fabrication model is not differentiable or is poorly differentiable.

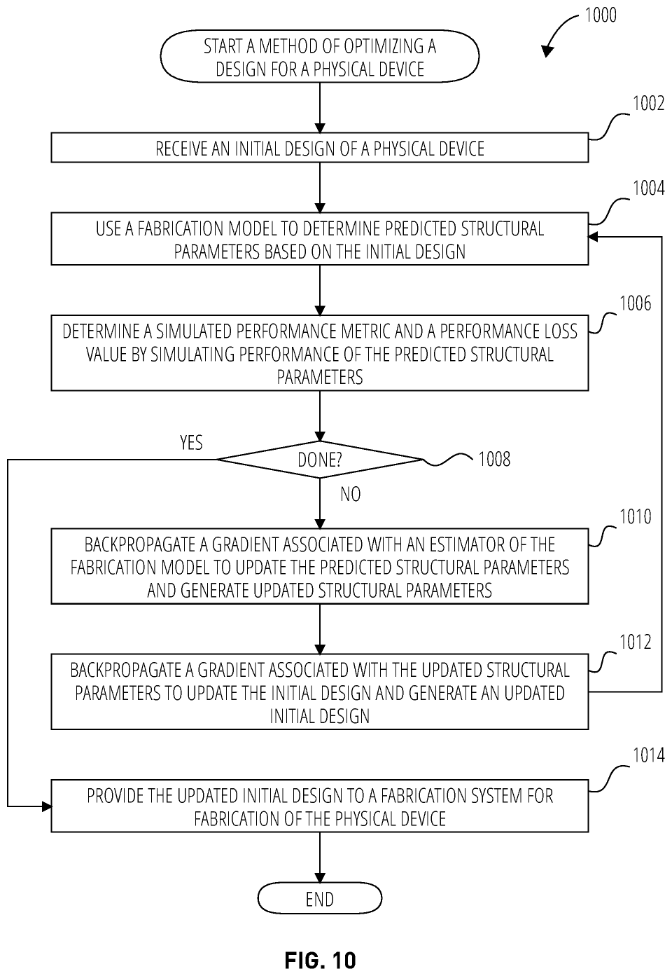

FIG. 10 is a flowchart that illustrates a non-limiting example embodiment of a method of optimizing a design for a physical device, in accordance with various aspects of the present disclosure. In the method 1000, an estimator is used to determine an estimated gradient associated with a fabrication model in an optimization process, so that backpropagation can be used to successfully optimize the design.

It is appreciated that method 1000 is a process that may be accomplished by performing operations with a system to perform iterative gradient-based optimization of an initial design 730 for a physical device. In the same or other embodiments, method 1000 may be included as instructions provided by at least one machine-accessible storage medium (e.g., non-transitory memory) that, when executed by a machine, will cause the machine to perform operations for generating and/or improving the initial design 730. It is further appreciated that the order in which some or all of the process blocks appear in method 1000 should not be deemed limiting. Rather, one of ordinary skill in the art having the benefit of the present disclosure will understand that some of the process blocks may be executed in a variety of orders not illustrated, or even in parallel.

From a start block, the method 1000 proceeds to block 1002, where an initial design 730 of a physical device such as a photonic integrated circuit is received. In some embodiments, the physical device may be expected to have a certain functionality (e.g., perform as an optical demultiplexer). The initial design may describe desired structural parameters of the physical device that are to be used for both fabrication and simulation.

At block 1004, the fabrication model is used to determine predicted structural parameters based on the initial design 730. Because the fabrication model is intended to represent changes from structures specified in the initial design 730 that are introduced by the fabrication process used by the fabrication system, the predicted structural parameters will likely be at least slightly different from the structure specified in the initial design 730. In some embodiments, a non-differentiable version (or poorly differentiable version) of the fabrication model, such as the examples discussed above in relation to FIG. 9A, may be used in order to produce a high quality result for the predicted structural parameters.

At block 1006, a simulated performance metric and a performance loss value are determined by simulating the performance of the predicted structural parameters. As discussed above, the simulated performance metric may be any suitable metric, including but not limited to a measurement of power transfer from one or more input ports to one or more output ports within one or more predetermined wavelength bands.

The method 1000 then proceeds to a decision block 1008, where a determination is made regarding whether optimization of the initial design 730 is complete. In some embodiments, the determination may be based on whether the performance loss value has met a threshold that indicates that the simulated performance of the physical device is high enough to be acceptable. In some embodiments, the determination may be based on whether the performance loss value has converged to a local or global minimum (i.e., further optimization iterations would be unlikely to provide further improvement to the performance loss value). In some embodiments, the determination may be based on whether a predetermined number of iterations of the method 1000 have been performed.

If it is determined that the optimization of the initial design 730 is not complete, then the result of decision block 1008 is NO, and the method 1000 proceeds to block 1010 to optimize the initial design 730 based on the performance loss value. At block 1010, a gradient associated with an estimator of the fabrication model is backpropagated to update the predicted structural parameters and thereby generate updated structural parameters. In some embodiments, the estimator of the fabrication model that is backpropagated is a straight-through estimator. In some embodiments, the estimator used may be a differentiable version of the fabrication model, such as the examples discussed above in relation to FIG. 9B, may be used in order to produce a gradient that is useful for optimization via backpropagation.

At block 1012, a gradient associated with the updated structural parameters is backpropagated to update the initial design 730 and thereby generate an updated initial design. Any suitable gradient may be used to update the initial design 730. In some embodiments, the gradient of the performance loss value may be used to directly update the structural parameters of the initial design 730. In some embodiments, another estimator may be used to estimate the gradient associated with the updated structural parameters, and the gradient of the estimator may be used. The method 1000 then returns to block 1004 to perform a subsequent iteration of the method 1000.

Returning to decision block 1008, if it is determined that the optimization of the initial design 730 is done, then the result of decision block 1008 is YES, and the method 1000 proceeds to block 1014. At block 1014, the updated fabrication model is provided to an inverse design process (such as the flow chart 700 illustrated and described above) for designing new physical devices to be fabricated by the fabrication system. By using the updated fabrication model, the process illustrated in the flow chart 700 can design more highly performant physical devices because the structural parameters 706 generated by the fabrication model 744 during the process more accurately represent the physical device that will be produced by the fabrication system.

The method 1000 then proceeds to an end block and terminates.

In the preceding description, numerous specific details are set forth to provide an understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

References throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having logic stored thereon that, in response to execution by one or more processors of a computing system, causes the computing system to perform actions for optimizing a design for a physical device to be fabricated by a fabrication system, the actions comprising:
receiving, by the computing system, an initial design of the physical device;
simulating, by the computing system, fabrication of the physical device using a fabrication model associated with the fabrication system to determine predicted structural parameters;
determining, by the computing system, a gradient of the fabrication model based on an estimator;
backpropagating, by the computing system, the gradient of the fabrication model to update the predicted structural parameters and thereby generate updated structural parameters; and
backpropagating, by the computing system, a gradient associated with the updated structural parameters to update the initial design and thereby generate an updated initial design.

2. The non-transitory computer-readable medium of claim 1, wherein the actions further comprise repeating the simulating, determining, and backpropagating actions two or more times.

3. The non-transitory computer-readable medium of claim 1, wherein the actions further comprise:
transmitting the updated initial design to the fabrication system for fabrication of the physical device.

4. The non-transitory computer-readable medium of claim 1, wherein the estimator is a straight-through estimator.

5. The non-transitory computer-readable medium of claim 1, wherein the fabrication model includes a convolution function multiplied by a beta parameter, wherein a first beta parameter is used while simulating fabrication of the physical device, and wherein a second beta parameter is used by the estimator.

6. The non-transitory computer-readable medium of claim 5, wherein the second beta parameter is smaller than the first beta parameter.

7. The non-transitory computer-readable medium of claim 5, wherein the fabrication model includes a hyperbolic tangent function.

8. The non-transitory computer-readable medium of claim 1, wherein the physical device is a photonic device.

9. The non-transitory computer-readable medium of claim 8, wherein the photonic device is a wavelength multiplexer or a wavelength demultiplexer.

10. The non-transitory computer-readable medium of claim 1, wherein the fabrication system is configured to perform a photolithography process.

11. A computer-implemented method of optimizing a design for a physical device to be fabricated by a fabrication system, the method comprising:
receiving, by a computing system, an initial design of the physical device;
simulating, by the computing system, fabrication of the physical device using a fabrication model associated with the fabrication system to determine predicted structural parameters;
determining, by the computing system, a gradient of the fabrication model based on an estimator;
backpropagating, by the computing system, the gradient of the fabrication model to update the predicted structural parameters and thereby generate updated structural parameters; and
backpropagating, by the computing system, a gradient associated with the updated structural parameters to update the initial design and thereby generate an updated initial design.

12. The computer-implemented method of claim 11, further comprising repeating the simulating, determining, and backpropagating actions two or more times.

13. The computer-implemented method of claim 11, further comprising:
transmitting the updated initial design to the fabrication system for fabrication of the physical device.

14. The computer-implemented method of claim 11, wherein the estimator is a straight-through estimator.

15. The computer-implemented method of claim 11, wherein the fabrication model includes a convolution function multiplied by a beta parameter, wherein a first beta parameter is used while simulating fabrication of the physical device, and wherein a second beta parameter is used by the estimator.

16. The computer-implemented method of claim 15, wherein the second beta parameter is smaller than the first beta parameter.

17. The computer-implemented method of claim 15, wherein the fabrication model includes a hyperbolic tangent function.

18. The computer-implemented method of claim 11, wherein the physical device is a photonic device.

19. The computer-implemented method of claim 18, wherein the photonic device is a wavelength multiplexer or a wavelength demultiplexer.

20. The computer-implemented method of claim 11, wherein the fabrication system is configured to perform a photolithography process.
